(19) United States
(12) Patent Application Publication
(10) Pub. No.: US 2010/0161539 A1
(43) Pub. Date: Jun. 24, 2010

(54) SYSTEM AND METHOD FOR ANALYZING TICKETS

(75) Inventors: Venket Kandanala, Highland Village, TX (US); Jubish Cheriya Parambath, Saligrammam (IN); Rajesh Narayanan, Nagar (IN); Shafiq Kassam, Lewisville, TX (US); Mohanakrishnan Vadivel, Ramavaram (IN)

Correspondence Address: VERIZON;PATENT MANAGEMENT GROUP, 1320 North Court House Road, 9th Floor, ARLINGTON, VA, 22201-2909, US

(73) Assignees: VERIZON DATA SERVICES INDIA PRIVATE LTD., Guindy (IN); VERIZON DATA SERVICES LLC, Temple Terrace, FL (US)

(21) Appl. No.: 12/337,944

(22) Filed: Dec. 18, 2008

(51) Int. Cl. G06N 5/02

(52) U.S. Cl. 706/47

(57) ABSTRACT

A system and method for analyzing tickets including an input configured to receive data associated with one or more tickets, one or more modules configured to analyze the received data, and an output configured to output the processed data. Each of the one or more tickets may be associated to at least one issue associated with at least one of a product and service. Analyzing the received data may include calibrating the one or more modules based on the received data and processing the data based on the calibration. The output may output the processed data for optimizing the at least one product and service and/or transmit the processed data into the input for further analysis at the one or more modules.

### BACKGROUND INFORMATION

Television, data, and voice services are popular among consumers. In fact, a single service provider may be capable of providing all of these services to its subscribers. However, subscribers of one or all of these services may have issues associated with these services which may require attention of the service provider. For every issue, a “ticket” may be generated by the service provider. Employees, representatives, and/or technicians of the service provider may respond to these tickets to resolve the corresponding issues of the subscriber in the ticket. In order to provide enhanced future service, monitoring and analyzing tickets may be important. For example, a service provider may receive a large number (e.g., 500,000) of tickets per month associated with its services, and many of the issues may be similar or may suggest a pattern or trend. By monitoring, analyzing, and/or categorizing the received/resolved tickets, a service provider may be able to establish a standard, streamlined approach to not only provide resolution to these issues, but to also improve overall product operations and support. As a result, as advancements in technology and corresponding problems/issues continue to rise, current systems may lack a technique to comprehensively and effectively to monitor and/or analyze root cause problems or patterns (e.g., in tickets) to enhance troubleshooting standards and overall product delivery.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system architecture for monitoring and analyzing tickets, according to an exemplary embodiment; and

FIG. 2 depicts a block diagram of an analytic module/system architecture for monitoring and analyzing tickets, according to an exemplary embodiment;

FIGS. 3A-3B depict a illustrative diagrams of weightage modules for monitoring and analyzing tickets, according to an exemplary embodiment;

FIG. 4 depicts a flowchart of a method for monitoring and analyzing tickets, according to an exemplary embodiment; and

FIG. 5 depicts a flowchart of a method for monitoring and analyzing tickets, according to another exemplary embodiment.

### DETAILED DESCRIPTION OF EMBODIMENTS

Reference will now be made in detail to exemplary embodiments, examples of which are illustrated in the accompanying drawings. It should be appreciated that the same reference numbers will be used throughout the drawings to refer to the same or like parts. It should be appreciated that the following detailed description are exemplary and explanatory only and are not restrictive.

Exemplary embodiments may provide a system and method for analyzing tickets. That is, exemplary embodiments may, among other things, expand and optimize analysis of tickets by comprehensively and effectively monitoring, analyzing, and/or categorizing tickets to enhance troubleshooting and overall product delivery.

It should be appreciated that the exemplary systems and methods are discussed in terms of monitoring, analyzing, and/or categorizing “tickets.” It should also be appreciated that as used herein, a “ticket,” “trouble ticket,” or “data/information associated to one or more tickets”⁷ may refer to any type “issue.” It should be appreciated that as used herein, “issue” may refer to any “questions, problems, issues, and/or resolutions relating to a product and/or service” and/or recorded in a ticket. For example, a ticket may be a repair request or other similar request identifying a particular issue. A ticket may also include data/information relating to how an issue is resolved.

A “ticket,” as used herein, may also be referred to as “data/information associated with one or more tickets.” It should be also be appreciated that a ticket may not necessarily be a physical ticket on paper. Rather, it may be any data/information that functions to track, document, and/or record any issue, as described herein.

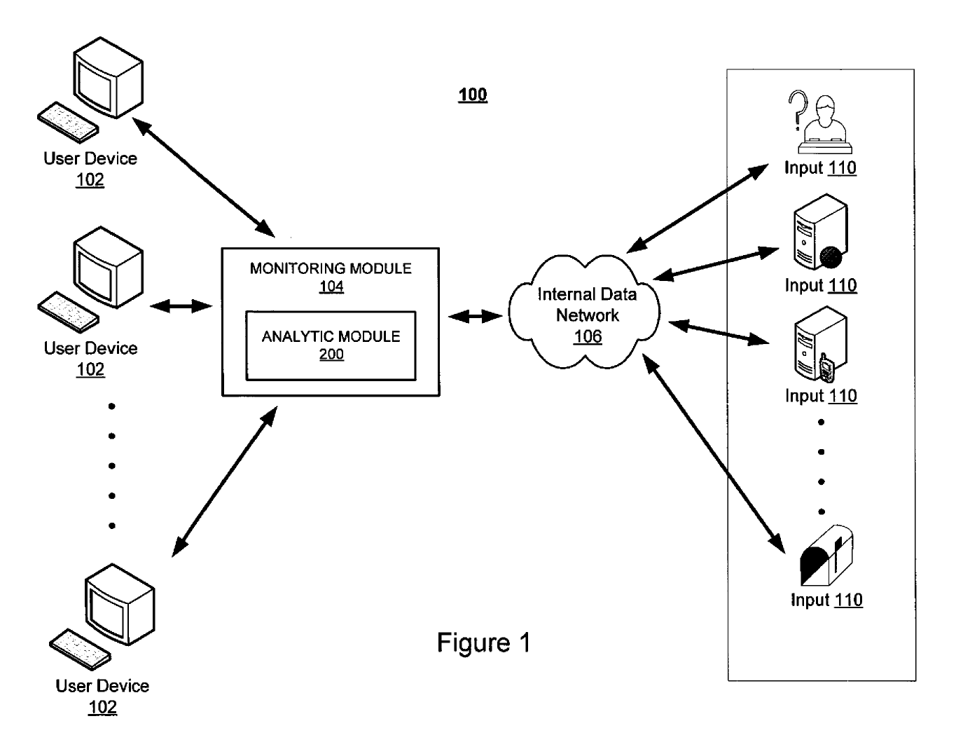

It should also be appreciated that a ticket may be generated in a number of ways. FIG. 1 illustrates a block diagram of an exemplary system 100 for monitoring and analyzing one or more tickets in accordance with an exemplary embodiment. The system 100 may monitor and/or analyze one or more tickets. In an exemplary embodiment, tickets may be submitted by customers, who are experiencing issues associated with a service (e.g., television services, Internet services, and/or telephone services) and/or equipment (e.g., wiring, set-up box, router, modem, television, and/or telephone) associated with a service. For example, the customers may experience issues associated with dropped wireless telephone calls, missing television channels, and/or lost of Internet connection. The customers may submit one or more tickets to a service provider to explain and/or resolve the issues. In an exemplary embodiment, the system 100 may include one or more inputs 110 (e.g., customer representatives, a telephone system, and/or an Internet server) that the users may use to submit the tickets. Also, the system 100 may include one or more user devices 102 which may interact with the one or more inputs 110 via a monitoring module 104 and/or an internal data network 106. The monitoring module 104 may include an analytic module/system 200 and/or other additional modules. The user may be associated with, but is not limited to, service providers, enterprises, educational institutions, government agencies, and any individual, group and/or organization running, maintaining and/or monitoring a network. Users within an organization may include, but are not limited to, network architects, network managers, engineers, planners, Network Operations Center (NOC) personnel, marketing, sales engineering, operations personnel, and customer support organizations. The user may monitor one or more parameters/keywords associated with the tickets submitted by user and generated by the one or more inputs 110. A relationship between various issues associated with the services and/or equipment and one or more parameters/keywords identified in the tickets may be established. For example, a power outage associated with the services and/or equipment may be related to thunderstorm and winds identified in the tickets. For example, the various parameters/keywords may include, but not limited to, a user name, account information, equipment, services, user's guides, geographical location, weather condition, troubleshooting, and/or other parameters a user may be interested to analyze/monitor. Also, one or more issues associated with services and/or equipment may include, but not limited to, issues associated with network elements and/or questions associated with television services features, Internet services features, telephone services features, installation, billing, and/or other issues a customer may experience.

The one or more user devices 102 may be a computer, a personal computer, a laptop, a cellular communication device, a global positioning system (GPS), a workstation, a mobile device, a phone, a handheld PC, a personal digital assistant (PDA), a thin system, a fat system, a network appliance, an Internet browser, a paging, an alert device, a television, an interactive television, a receiver, a tuner, a high definition (HD) television, a HD receiver, a video-on-demand (VOD) system, and/or other any other device that may allow a user to communicate with the monitoring module 104 via one or more networks (not shown) as known in the art.

A monitoring module 104 may be one or more servers. The monitoring module 104 may include a SQL Server, UNIX based servers, Windows 2000 Server, Microsoft IIS server, Apache HTTP server, API server, Java sever, Java Servlet API server, ASP server, PHP server, HTTP server, Mac OS X server, Oracle server, IP server, and/or other independent server to monitor and/or analyze the tickets generated by the one or more inputs 110. Also, the monitoring module 104 may store and/or run a variety of software, for example, Microsoft .NET framework.

The internal data network 106 may be coupled to the one or more inputs 110 via a management Ethernet port (not shown). The internal data network 106 may be a wireless network, a wired network or any combination of wireless network and wired network. For example, the internal data network 106 may include, without limitation, Internet network, satellite network (e.g., operating in Band C, Band Ku and/or Band Ka), wireless LAN, Global System for Mobile Communication (GSM), Personal Communication Service (PCS), Personal Area Network (PAN), D-AMPS, Wi-Fi, Fixed Wireless Data, satellite network, IEEE 802.11a, 802.11b, 802.15.1, 802.11n and 802.11g and/or any other wireless network for transmitting a signal. In addition, the internal data network 106 may include, without limitation, telephone line, fiber optics, IEEE Ethernet 802.3, wide area network (WAN), local area network (LAN), global network such as the Internet. Also, the internal data network 106 may enable, an Internet network, a wireless communication network, a cellular network, an Intranet, or the like, or any combination thereof. The internal data network 106 may further include one, or any number of the exemplary types of networks mentioned above operating as a stand-alone network or in cooperation with each other.

A user associated with the one or more user devices 102 may interactively browse, monitor, and/or analyze tickets generated by the one or more inputs 110 to display various information associated with the tickets via the one or more user devices 102. For example, the one or more inputs 110 may include, but is not limited to, a customer representative, an automated telephonic service, an Internet website/webpage, a mail postal service, and/or other methods of communicating issues associated with services and/or equipment. Also, the one or more inputs 110 may include telephone systems and/or Internet servers. In an exemplary embodiment, the one or more inputs 110 may be a customer representative (e.g., a live person) and a customer may contact the customer representative via a telephone, a computer and/or in person. The customer representative may generate one or more tickets for the customer that is experiencing issues associated with services and/or equipment. In another exemplary embodiment, the one or more inputs 110 may be an automated telephone service, where a customer may dial into a telephone system to report issues associated with services and/or equipment. The telephone system may prompt the customer for response to one or more questions and generate one or more tickets based on the customer's response. In other exemplary embodiments, the one or more inputs 110 may be an Internet website/webpage hosted by an Internet server. For example, customers may access the website/webpage and report issues associated with services and/or equipment. In an additional exemplary embodiment, the one or more inputs 110 may be a mail postal service, where a customer may mail a letter and/or a ticket to a service provider to report issues associated with service and/or equipment. Also, the one or more inputs 110 may be located at various geographical locations (e.g., various cities, zip codes, states, and/or countries) for servicing users located at the various geographical locations. Further, one or more inputs 110 may be include one or more user input interface in order to allow the users to enter information associated with the issues of the services and/or the equipment.

As discussed above, for example, a ticket may be generated via telephone call (e.g., a subscriber calling a service provider and speaking with service provider representative), electronic submission (e.g., the subscriber transmitting a service requests via the service provider's website, email), or other similar action. In these examples, the service provider may provide a number of call centers and/or web agents to receive, interpret, and/or resolve the subscribers' questions or requests.

There may be a large number (e.g., 500,000) of tickets related to television, data, and voice services on a monthly basis. However, manual response to these tickets to resolve, analyze, and/or categorize the root causes and/or patterns may be highly time consuming, not to mention large quantities of resources may also be expended. Additionally, by reading through many unrelated tickets covering a wide range of issues in varying fields, accurate results may not be readily attainable. Lack of uniformity and standardization may also contribute to imprecise analysis.

For example, two or more subscribers may identify a similar issue with a service offered by their service provider. One of the subscribers may report an issue via telephone by speaking with a service provider representative. The representative may generate a ticket, help the subscriber resolve the issue, and record the entire transaction in the ticket (e.g., how the subscriber described the issue, how the representative interpreted the issue, how it was eventually resolved, etc.). A second subscriber may encounter the same issue and may also report the issue via telephone. However, the second subscriber, although encountering the same issue as the first subscriber, may describe the issue differently than the first subscriber. Furthermore, she may speak with different service provider representative, who also interprets the issue in a different way. Although the issue eventually gets resolved, this ticket that is generated may include different elements than that of the ticket corresponding to the first subscriber. A third subscriber may also encounter the same issue, but rather than calling in, she may transmit a repair request via electronic submission (e.g., through the service provider's website or by email). In this case, a ticket may be generated based on her electronic submission by a computer or other similar automated system. Accordingly, the ticket generated in this case may be different (e.g., containing different elements, description of the issue, method of resolving the issue, etc.) than that of the other aforementioned tickets. Therefore, when these tickets are analyzed, they may be analyzed/categorized differently. As a result, when analyzing a large quantity of related and unrelated tickets covering a wide range of issues in varying fields, reliable analysis (e.g., categorizing these tickets in the same/similar way) may prove difficult.

Additional error (e.g., human error) associated with manual and/or non-standardized analysis may further decrease reliability. Thus, establishing an efficient and standardized approach may not only provide resolution to these issues, but to also improve troubleshooting and overall product operations and support.

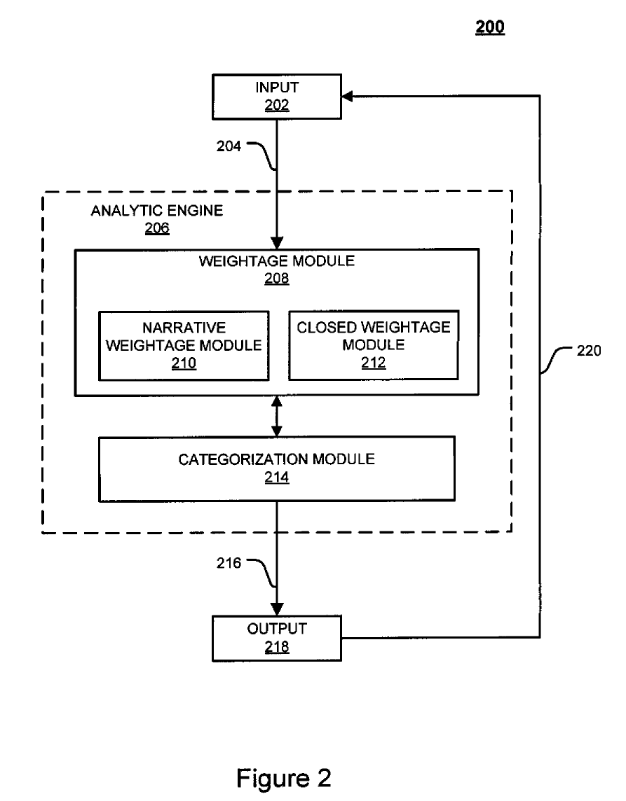

FIG. 2 depicts a block diagram of an analytic module/system 200 architecture for monitoring and analyzing tickets, according to an exemplary embodiment. It should be appreciated that system 200 is a simplified view for analyzing tickets and may include additional elements that are not depicted. As illustrated, the system 200 may include an input 202. The input 202 may receive one or more tickets for analysis. The input 202 may receive tickets via manual feed, automatic feed, other alternative types of feed, or a combination thereof. The input 202 may be communicatively coupled to an analytic engine 206, which receives the input 202 associated with one or more tickets for analysis from at least the input 202. It should be appreciated that in some embodiments, the input 202 and/or the analytic engine 206 may translate/convert/reformat the data for compatibility. The one or more tickets may be analyzed by the analytic engine 206 at a weightage module 208 and/or a categorization module 214. The weightage module 208 may further include a narrative weightage module 210, a closed weightage module 212, and/or or other similar weightage module. Once the one or more tickets are analyzed by the analytic engine 206, the processed data 216 associated with the one or more analyzed tickets may be transmitted to an output 218 for troubleshooting or overall product operations and support, and/or the one or more processed data 216 may be transmitted back to the input 202 for further ticket analysis at the analytic engine 206.

The input 202 may receive a variety of tickets in a variety of ways and/or formats. For example, as described above, tickets may be generated by a service provider agent, via the web, and/or other ticket generation methodologies (e.g., electronically, automatically, etc.). Accordingly, it should be appreciated that the input 202 may format/reformat one or more tickets (e.g., in the form of data feed 204) for adequate transmission to the analytic engine 206 for analysis/processing.

The analytic engine 206 may include one or more servers, server-like systems, and/or modules configured to analyze tickets. The analytic engine 206 may use at least the weightage module 208, which includes the narrative module 210, the closed weightage module 212, and/or other weightage module, and the categorization module 214 to analyze the one or more tickets received from the input 202. By parsing text/fields of each ticket, which may include approximately 50-70 fields per ticket, the weightage module 208 may determine what text/fields are relevant/irrelevant and weigh these text/fields appropriately for proper categorization/analysis. The narrative weightage module 210 may determine and weigh the text/fields from the subscriber's description, or “narrative,” of the issue and/or request. The narrative weightage module 210 may determine and weigh the text/fields of each ticket based on a respective subscriber's description of the issue and/or request. The closed weightage module 212 may determine and weigh the text/fields of each ticket based on a description of the service provider as to how the issue and/or request was resolved or “closed out.” As described above, even though the issues underlying two or more tickets may be the same (or similar), the subscriber and the service provider may describe these issues differently. Also, the approach or way to resolve the same issue, as recorded in the ticket, may be different as well. As a result, the weightage module 208 may use processing logic to determine and weigh the text/fields of each ticket for more efficient and accurate ticket analysis.

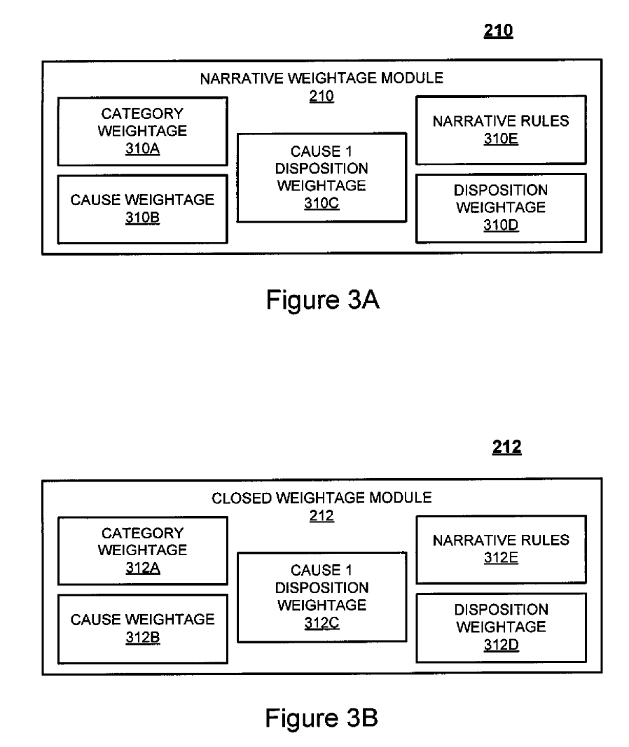

It should be appreciated that the weightage module 208 may process/analyze tickets based on several additional weightage criteria. FIGS. 3A-3B depict a illustrative diagrams of weightage modules for monitoring and analyzing tickets, according to an exemplary embodiment. For instance, as depicted in FIG. 3A, the narrative weightage module 210 may analyze each ticket based on category 310A, cause 310B, disposition 310D, cause 1 disposition 310C, narrative rules 310E, and/or other criteria. As depicted in FIG. 3B, the closed weightage module 212 may analyze each ticket based on category 312A, cause 312B, disposition 312D, cause 1 disposition 312C, narrative rules 312E, and/or other criteria. These criteria—category, cause, disposition, cause 1 disposition, narrative rules, and/or other criteria—may be applied to help determine and/or filter each ticket for its relevant portions for weighing and analysis. For example, each ticket may be filtered and/or weighed for analysis based on “category” of each ticket, “cause” or problem identified in each ticket, how each ticket/issue is “disposed,” various “dispositions” to each “cause,” rules applied to “narrative” portions in each ticket, etc. It should be appreciated that these criteria may be generated based on initial calibration of the analytic engine 206. Other various embodiments may also be provided.

The categorization module 214 of the analytic engine 206 may then receive data analyzed by the weightage module 208 and determine an appropriate categorization for each ticket. Such categorization may be useful for further analysis of tickets. For example, in the event the tickets are generally related to television service, particularly a new set top box provided by the service provider, examples of categories may include, but not limited to, powering on/off the set top box, changing channels, remote control issues, overheating, connectivity, etc. Depending on the tickets and/or the calibrated weightage criteria, these categories may be broader or narrower. By categorizing each analyzed ticket, root cause problems and patterns may be more easily identified. For example, in the event a majority of the tickets received/resolved by a service provider are directed to a power issue of a particular set top box, the service provider may be able identify this problem and resolve it in a variety of ways. These may include, for example, recalling that particular set top box, issue a general fix for all those who use that particular set top box, provide an upgraded set top box that does not have that same problem, make note of the problem as in developing the new version of that set top box. Other various embodiments may also be provided.

For example, after tickets are analyzed/processed by the analytic engine 206, the processed data 216 may be transmitted to the output 218. Here, the data/information associated with the tickets may be used to improve product support and delivery. For instance, the analysis of tickets may indicate that the release of a particular version of television service by the service provider had a several issues with connectivity with a certain television or a poor connection in certain geographic areas, etc. The service provider of the television service may then use this information at the output 218 to universally repair this particular television service feature and/or implement upgrades, patches, and/or other improvements in future releases/versions. Other various embodiments may also be provided.

The processed data 216 associated with the one or more tickets may also be transmitted back to the input 202 via a feedback loop 220 for further analysis. Such feedback may be helpful for improving accuracy and reliability of ticket analysis by the analytical engine 206. For example, it should be appreciated that the first time data/information transmitted to the analytic engine 206 may serve as an initial calibration of the analytic engine. For example, in the event 10,000 tickets are received by the analytic engine, the analytic engine 206 may generate a variety of rules for the weightage module 208 and/or form/update various categories at the categorization module 214 based on these received 10,000 tickets. As a result, subsequent ticket information/data fed into the analytic engine 206 may be properly weighted and/or categorized. However, the weightage rules and/or categorizations may be based only on the 10,000 initial feed of tickets, which may not represent a wholly accurate ticket analysis system at that point. For instance, feeding another batch of tickets may only yield a 40% success rate of proper analysis because this new batch of tickets may not use all the same rules or fall into the categories initially generated. Therefore, by feeding back the processed data 216 to the input 202 for further analysis by the analytic engine 206, the analytic engine 206 re-analyze the ticket data/information to generate more rules/categories for a more accurate analysis. In this way, the analytic engine 206, within this feedback loop 220, may continue to recalibrate to be self- or near self-learning system that may include processing logic capable of improving itself for more accurate and reliable ticket analysis. It should be appreciated that after a predetermined amount of time (e.g. six (6) months) of recalibrating and improving itself, the analytic engine 206 may be operate more stably and independently to analyze tickets with greater accuracy and reliability. Other various embodiments may also be realized.

It should be appreciated that each of the components of the system 200 may be configured to receive, transmit, and/or process signals/data. For example, each of servers, server-like systems, and/or modules of the analytic engine 206 may have one or more receivers, one or more transmitters, and/or one or more processors in order to communicate (e.g., receive, process, and/or transmit data/information) with the other components of system 200. Communications may be achieved via transmission of electric, electromagnetic, optical, or wireless signals and/or packets that carry digital data streams using a standard telecommunications protocol and/or a standard networking protocol. These may include Session Initiation Protocol (SIP), Voice Over IP (VOIP) protocols, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols. Other protocols and/or systems that are suitable for transmitting and/or receiving data via packets/signals may also be provided. For example, cabled network or telecom connections such as an Ethernet RJ45/Category 5 Ethernet connection, a fiber connection, a traditional phone wireline connection, a cable connection or other wired network connection may also be used. Communication between the network providers and/or subscribers may also use standard wireless protocols including IEEE 802.11a, 802.11b, 802.11g, etc., or via protocols for a wired connection, such as an IEEE Ethernet 802.3.

It should be appreciated that communications between components of system 200 may be conducted over a network (not shown), such as a local area network (LAN), a wide area network (WAN), a service provider network, the Internet, or other similar network. It should be appreciated that the network may use electric, electromagnetic, and/or optical signals that carry digital data streams.

It should also be appreciated that the components of system 200 may be used independently or may be used as an integrated component in another device and/or system. It should also be appreciated that the devices, modules, and/or components of system 200 are shown as separate components, these may be combined into greater or lesser components to optimize flexibility. The devices, modules, and/or components of system 200 may also be local, remote, or a combination thereof to each other or other system components. Other various embodiments may also be realized.

While depicted as components, servers, modules, platforms, and/or devices of the system 200, it should be appreciated that embodiments may be constructed in software and/or hardware, as separate and/or stand-alone, or as part of an integrated transmission and/or switching device/networks. For example, it should also be appreciated that the one or more network components, servers, modules, platforms, and/or devices of the system 200 may not be limited to physical components. These components may be software-based, virtual, etc. Moreover, the various components, servers, modules, and/or devices may be customized to perform one or more additional features and functionalities. Also, although depicted as singular network or system components, each of the various networks or system components may be equal, greater, or lesser.

Additionally, it should also be appreciated that support and updating of the various components of the system 200 may be easily achieved. For example, an administrator may have access to one or more of these networks or system components. Such features and functionalities may be provided via deployment, transmitting and/or installing software/hardware.

It should also be appreciated that each of the system components may include one or more processors, servers, modules, and/or devices for optimizing ticket analysis. It should be appreciated that one or more data storage systems (e.g., databases) (not shown) may also be coupled to each of the one or more processors, servers, modules, and/or devices of the system 200 to store relevant information for each of the servers and system components. Other various embodiments may also be provided. The contents of any of these one or more data storage systems may be combined into fewer or greater number of data storage systems and may be stored on one or more data storage systems and/or servers. Furthermore, the data storage systems may be local, remote, or a combination thereof to clients systems, servers, and/or other system components. In another embodiment, information stored in the databases may be useful in providing additional customizations for optimizing ticket analysis implementation. Other various embodiments and variations may also be realized.

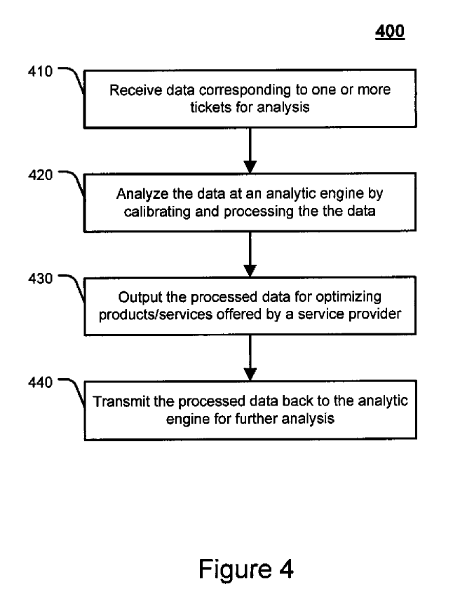

FIG. 4 depicts a flowchart of a method for analyzing tickets, according to an exemplary embodiment. The exemplary method 400 is provided by way of example, as there are a variety of ways to carry out methods disclosed herein. The method 400 shown in FIG. 4 may be executed or otherwise performed by one or a combination of various systems. The method 400 is described below as carried out by at least system 200 in FIG. 2, by way of example, and various elements of systems 200 are referenced in explaining the example method of FIG. 4. Each block shown in FIG. 4 represents one or more processes, methods, or subroutines carried in the exemplary method 400. A computer readable media comprising code to perform the acts of the method 400 may also be provided. Referring to FIG. 4, the exemplary method 400 may begin at block 410.

At block 410, data corresponding to one or more tickets may be received. For example, the analytic engine 206 may receive data corresponding to one or more tickets from the input 202. It should be appreciated that each of the one or more tickets may be associated with at least one issue of at least one of a product and service. It should also be appreciated that the data may be reformatted at the input 202 and/or the analytic engine 206 for analysis at the analytic engine 206.

At block 420, the data corresponding to the one or more tickets may be analyzed. For example, the analytic engine 206 may analyze the data corresponding to one or more tickets. In this example, the data may be analyzed in several ways. In one embodiment, the weightage module 208 and the categorization module 214 may cooperatively calibrate the analytic engine 206 based on the received data and process the data based on the calibration. Specifically, calibrating the analytic engine 206 may be achieved by at least the weightage module 208 creating weightage rules and the categorization module 214 generating categories for analyzing the data.

It should be appreciated that weightage rules may be based on the data corresponding to the one or more tickets in at least one of category, cause, disposition, cause 1 disposition, narrative rules, and/or other criteria. It should also be appreciated that the weightage rules may include at least one of narrative weightage rules (e.g., created by the narrative weightage module 210) and closed weightage rules (e.g., created by the closed weightage module 212) such that the narrative weightage rules may, for example, relate how the at least one issue is described by at least a subscriber and service provider, and the closed weightage rules, for example, may relate to how the at least one issue was resolved.

During calibration, the categorization module 214 may generate categories based on at least one of the data, the weightage rules, keywords, pattern matching, and root cause analysis. It should be appreciated that calibration may be repeated and may be performed simultaneously, or near simultaneously, with data processing. For example, when the analytic engine 206 calibrates itself using the data, the analytic engine 206 may also process/analyze the data by categorizing the data in one or more of the categories generated by the categorization module 214.

At block 430, the processed data 216 may also be outputted. For example, an output at the analytic engine 206 may output the processed data 216 for optimizing the at least one product and service corresponding to the at least one issue in the ticket data. In this example, optimizing the at least one product and service comprises at least one of establishing a standardized approach to the at least one issue, determining one or more root causes for the at least one issue, repairing the at least one product and service, enhancing the at least one product and service, improving support for the at least one product and service, and/or other various enterprises.

It should be appreciated that although embodiments are described primarily with ticket analysis, the systems and methods discussed above are provided as merely exemplary and may have other applications. These may include any application/analysis related to enterprise level product or services where issue patterning and/or root-cause analysis may be useful. Embodiments may also be beneficial for training, coaching, updating, fieldwork, and/or other similar area.

At block 440, the processed data 216 may be transmitted in a feedback loop 220. For example, the output 218 may transmit the processed data 216 back into the input 202 (or the analytic engine 206) for further analysis of the data. Accordingly, transmitting the processed data back into the input for further analysis at the analytic engine 206 (e.g., via the input 202) may be repeatable. It should be appreciated that further analysis at the analytic engine 206 may include recalibrating the analytic engine 206 (e.g., the weightage module 208 and the categorization module 214), which may improve accuracy of the processed data 216.

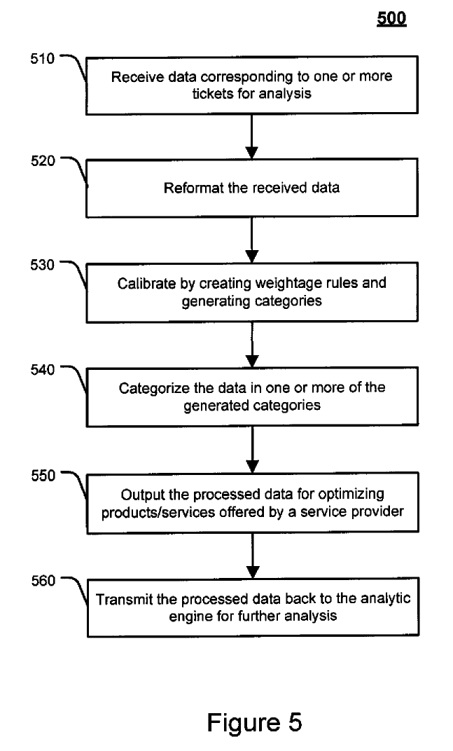

FIG. 5 depicts a flowchart of a method for analyzing tickets, according to an exemplary embodiment. The exemplary method 500 is provided by way of example, as there are a variety of ways to carry out methods disclosed herein. The method 500 shown in FIG. 5 may be executed or otherwise performed by one or a combination of various systems. The method 500 is described below as carried out by at least system 200 in FIG. 2, by way of example, and various elements of systems 200 are referenced in explaining the example method of FIG. 5. Each block shown in FIG. 5 represents one or more processes, methods, or subroutines carried in the exemplary method 500. A computer readable media comprising code to perform the acts of the method 500 may also be provided, Referring to FIG. 5, the exemplary method 500 may begin at block 510.

At block 510, data corresponding to one or more tickets may be received. For example, the analytic engine 206 may receive data corresponding to one or more tickets from the input 202. It should be appreciated that each of the one or more tickets may be associated with at least one issue of at least one of a product and service. It should also be appreciated that the data may be reformatted at the input 202 and/or the analytic engine 206 for analysis at the analytic engine 206.

At block 520, the data corresponding to the one or more tickets may be reformatted. For example, the data may be reformatted at the input 202 and/or the analytic engine 206 for analysis at the analytic engine 206.

At block 530, the data corresponding to the one or more tickets may be used for calibration. For example, the weightage module 208 and the categorization module 214 of the analytic engine 206 may cooperatively calibrate the analytic engine 206 based on the received data and process the data based on the calibration. Specifically, calibrating the analytic engine 206 may be achieved by at least the weightage module 208 creating weightage rules and the categorization module 214 generating categories for analyzing the data.

It should be appreciated that weightage rules may be based on the data corresponding to the one or more tickets in at least one of category, cause, disposition, cause 1 disposition, narrative rules, and/or other criteria. It should also be appreciated that the weightage rules may include at least one of narrative weightage rules (e.g., created by the narrative weightage module 210) and closed weightage rules (e.g., created by the closed weightage module 212) such that the narrative weightage rules may, for example, relate how the at least one issue is described by at least a subscriber and service provider, and the closed weightage rules, for example, may relate to how the at least one issue was resolved.

At block 540, the categorization module 214 may generate categories based on at least one of the data, the weightage rules, keywords, pattern matching, and root cause analysis. It should be appreciated that calibration may be repeated and may be performed simultaneously, or near simultaneously, with data processing. For example, when the analytic engine 206 calibrates itself using the data, the analytic engine 206 may also process/analyze the data by categorizing the data in one or more of the categories generated by the categorization module 214.

At block 550, the processed data 216 may also be outputted. For example, an output at the analytic engine 206 may output the processed data 216 for optimizing the at least one product and service corresponding to the at least one issue in the ticket data. In this example, optimizing the at least one product and service comprises at least one of establishing a standardized approach to the at least one issue, determining one or more root causes for the at least one issue, repairing the at least one product and service, enhancing the at least one product and service, improving support for the at least one product and service, and/or other various enterprises.

It should be appreciated that although embodiments are described primarily with ticket analysis, the systems and methods discussed above are provided as merely exemplary and may have other applications. These may include any application/analysis related to enterprise level product or services where issue patterning and/or root-cause analysis may be useful. Embodiments may also be beneficial for training, coaching, updating, fieldwork, and/or other similar area.

At block 560, the processed data 216 may be transmitted in a feedback loop 220. For example, the output 218 may transmit the processed data 216 back into the input 202 (or the analytic engine 206) for further analysis of the data. Accordingly, transmitting the processed data back into the input for further analysis at the analytic engine 206 (e.g., via the input 202) may be repeatable. It should be appreciated that further analysis at the analytic engine 206 may include recalibrating the analytic engine 206 (e.g., the weightage module 208 and the categorization module 214), which may improve accuracy of the processed data 216.

It should be appreciated that one or more databases (not shown) may be communicatively coupled to the input 202, analytic engine 206, and/or the output 218 to store data/information associated with the one or more tickets. For example, in one embodiment, the input 202 may store received data/information until a predetermined threshold is met before transmitting to the analytic engine 206. In another embodiment, the analytic engine 206 and/or output 218 may have one or more databases (not shown) to store the weightage rules, categories, and/or processed data. This information/data may be retrieved by the analytic engine 206 and/or output 218 for future use. Other various embodiments may also be provided.

Although embodiments are directed to analysis of tickets in services relating to television, data, and/or voice, it should be appreciated that analysis outside of these ticketed services may also be provided. These may include secure communications, comprehensive network maintenance/support, hardware/software delivery, e-commerce, financial/banking services, entertainment, marketing, and advertisement related services, etc.

It should also be appreciated that exemplary embodiments may support one or more additional security and/or business functions/features. For example, while ticket analysis is described as being implemented at the analytic engine 206, embodiments may be implemented at one, all, or a combination of at least the other components depicted in system 200.

It should be appreciated that while exemplary embodiments are described as being implemented over wired networks and systems, other various embodiments may also be provided. For example, registration may be implemented over wireless networks or systems. Whether wired or wireless, the network and/or system may be a local area network (LAN), wide area network (WAN), or any other network configuration. Additionally, various communication interfaces may be used. These may include an integrated services digital network (ISDN) card or a modem to provide a data communication connection. In another embodiment, the communication interface may be a local area network (LAN) card to provide a data communication connection to a compatible LAN. Wireless links (e.g., microwave, radio, etc.) may also be implemented. In any such implementation, the communication interface may send and receive electrical, electromagnetic, and/or optical signals that carry digital data streams representing various types of information.

In one embodiment, the wireline network/system may include long-range optical data communications, local area network based protocols, wide area networks, and/or other similar applications. In another embodiment, wireless broadband connection may include long-range wireless radio, local area wireless network such as Wi-Fi (802.11xx) based protocols, wireless wide area network such as Code Division Multiple Access (CDMA)-Evolution Data Only/Optimized (EVDO), Global System for Mobile-Communications (GSM)-High Speed Packet Access (HSPA), WiMax, infrared, voice command, Bluetooth™, Long Term Evolution (LTE), and/or other similar applications. In yet another embodiment, the network with which communications are made may include the Internet or World Wide Web. Other networks may also be utilized for connecting each of the various devices, systems and/or servers.

By performing the various features and functions as discussed above, the systems and methods described may allow comprehensive and efficient analysis of tickets and other similar enterprise product enhancement and/or servicing.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A method, comprising:
receiving, at an analytic engine, data corresponding to one or more tickets, wherein each of the one or more tickets is associated with at least one issue of at least one of a product and service;
analyzing the data at the analytic engine, wherein analyzing the data comprises calibrating the analytic engine based on the received data and processing the data based on the calibration; and
outputting, from the analytic engine, the processed data for optimizing the at least one product and service.

2. The method of claim 1, further comprising transmitting the processed data into the input for further analysis at the analytic engine.

3. The method of claim 2, wherein the processed data is transmitted into the input for further analysis at the analytic engine on a repetitive basis.

4. The method of claim 2, wherein further analysis at the analytic engine comprises re-calibrating the analytic engine and improving accuracy of the processed data.

5. The method of claim 1, wherein the data is reformatted for analysis in at least one of the input and the analytic engine.

6. The method of claim 1, wherein calibrating the analytic engine comprises creating weightage rules and generating categories for analyzing the data.

7. The method of claim 6, wherein creating weightage rules is based on the data corresponding to the one or more tickets in at least one of category, cause, disposition, cause 1 disposition, and narrative rules.

8. The method of claim 6, wherein the weightage rules comprises at least one of narrative weightage rules and closed weightage rules, wherein the narrative weightage rules relates to how the at least one issue is described by at least a subscriber and a service provider, and wherein the closed weightage rules relates to how the at least one issue was resolved.

9. The method of claim 6, wherein generating categories is based on at least one of the data, the weightage rules, keywords, pattern matching, and root cause analysis.

10. The method of claim 6, wherein processing the data comprises categorizing the data in one or more of the categories.

11. The method of claim 1, wherein optimizing the at least one product and service comprises at least one of establishing a standardized approach to the at least one issue, determining one or more root causes for the at least one issue, repairing the at least one product and service, enhancing the at least one product and service, and improving support for the at least one product and service.

12. A computer readable medium comprising code to perform the acts of the method of claim 1.

13. A system, comprising:
an input configured to receive data associated with one or more tickets, wherein each of the one or more tickets are associated to at least one issue associated with at least one of a product and service;
one or more modules configured to analyze the received data by calibrating the one or more modules based on the received data and processing the data based on the calibration; and
an output configured to output the processed data for optimizing the at least one product and service and to transmit the processed data into the input for further analysis at the one or more modules.

15. The system of claim 13, wherein the output is configured, on a repetitive basis, to transmit the processed data into the input for further analysis at the one or more modules.

16. The system of claim 13, wherein further analysis at the one or more modules comprises re-calibrating the one or more modules and improving accuracy of the processed data.

17. The system of claim 13, wherein the data is reformatted for analysis in at least one of the input and one or more modules.

18. The system of claim 13, wherein calibrating the one or more modules comprises creating weightage rules and generating categories for analyzing the data.

19. The system of claim 18, wherein creating weightage rules is based on the data corresponding to the one or more tickets in at least one of category, cause, disposition, cause 1 disposition, and narrative rules.

20. The system of claim 18, wherein the weightage rules comprises at least one of narrative weightage rules and closed weightage rules, wherein the narrative weightage rules relates to how the at least one issue is described by at least a subscriber and a service provider, and wherein the closed weightage rules relates to how the at least one issue was resolved.

21. The system of claim 18, wherein generating categories is based on at least one of the data, the weightage rules, keywords, pattern matching, and root cause analysis.

22. The system of claim 18, wherein processing the data comprises categorizing the data in one or more of the categories.

23. The system of claim 13, wherein optimizing the at least one product and service comprises at least one of establishing a standardized approach to the at least one issue, determining one or more root causes for the at least one issue, repairing the at least one product and service, enhancing the at least one product and service, and improving support for the at least one product and service.
